(19) United States
(12) Patent Application Publication
(10) Pub. No.: US 2013/0054233 A1
(43) Pub. Date: Feb. 28, 2013

(54) Method, System and Computer Program Product for Attenuating Noise Using Multiple Channels

(71) Applicants: Takahiro Unno, Richardson, TX (US); Baboo Vikrhamsingh Gowreesunker, Dallas, TX (US)

(72) Inventors: Takahiro Unno, Richardson, TX (US); Baboo Vikrhamsingh Gowreesunker, Dallas, TX (US)

(73) Assignee: TEXAS INSTRUMENTS INCORPORATED, Dallas, TX (US)

(21) Appl. No.: 13/592,708

(22) Filed: Aug. 23, 2012

Related U.S. Application Data
(63) Continuation-in-part of application No. 13/589,237, filed on Aug. 20, 2012.
(60) Provisional application No. 61/526,941, filed on Aug. 24, 2011.
(60) Provisional application No. 61/526,962, filed on Aug. 24, 2011.

(51) Int. Cl. G10L 21/02

(52) U.S. Cl. 704/226; 704/E21.002

(57) ABSTRACT

A first signal is received that represents speech and the noise. The noise includes directional noise and diffused noise. A second signal is received that represents the noise and leakage of the speech. In response to the first and second signals: a first channel is generated that represents the speech and the diffused noise while attenuating most of the directional noise from the first signal; and a second channel is generated that represents the noise while attenuating most of the speech from the second signal. In response to the first and second channels, an output channel is generated that represents the speech while attenuating most of the noise from the first channel.

### CROSS-REFERENCE TO RELATED APPLICATIONS

This application claims priority to U.S. Provisional Patent Application Ser. No. 61/526,941, filed Aug. 24, 2011, entitled TWO-CHANNEL NON-LINEAR NOISE SUPPRESSOR WITH DE-CORRELATION FILTER PREPROCESSING, naming Takahiro Unno et al. as inventors.

This application claims priority to and is a continuation-in-part of co-owned co-pending U.S. patent application Ser. No. 13/589,237, filed Aug. 20, 2012, entitled METHOD, SYSTEM AND COMPUTER PROGRAM PRODUCT FOR ATTENUATING NOISE IN MULTIPLE TIME FRAMES, naming Takahiro Unno as inventor, which claims priority to U.S. Provisional Patent Application Ser. No. 61/526,962, filed Aug. 24, 2011, entitled JOINT A PRIORI SNR AND POSTERIOR SNR ESTIMATION FOR BETTER SNR ESTIMATION AND SNR-ATTENUATION MAPPING IN NON-LINEAR PROCESSING NOISE SUPPRESSOR, naming Takahiro Unno as inventor.

All of the above-identified applications are hereby fully incorporated herein by reference for all purposes.

### BACKGROUND

The disclosures herein relate in general to audio processing, and in particular to a method, system and computer program product for attenuating noise using multiple channels.

In mobile telephone conversations, improving quality of uplink speech is an important and challenging objective. One previous technique, with one microphone, estimates stationary noise in a primary channel's signal, yet fails to remove non-stationary noise. Another previous technique, with two microphones, estimates a phase of a primary channel's noise signal, yet fails to remove diffused noise.

### SUMMARY

A first signal is received that represents speech and the noise. The noise includes directional noise and diffused noise. A second signal is received that represents the noise and leakage of the speech. In response to the first and second signals: a first channel is generated that represents the speech and the diffused noise while attenuating most of the directional noise from the first signal; and a second channel is generated that represents the noise while attenuating most of the speech from the second signal. In response to the first and second channels, an output channel is generated that represents the speech while attenuating most of the noise from the first channel.

### BRIEF DESCRIPTION OF THE DRAWINGS

FIG. 1 is a perspective view of a mobile smartphone that includes an information handling system of the illustrative embodiments.

FIG. 2 is a block diagram of the information handling system of the illustrative embodiments.

FIG. 3 is an information flow diagram of an operation of the system of FIG. 2.

FIG. 4 is an information flow diagram of a blind source separation operation of FIG. 3.

FIG. 5 is an information flow diagram of a post processing operation of FIG. 3.

FIG. 6 is a graph of various frequency bands that are applied by a discrete Fourier transform (“DFT”) filter bank operation of FIG. 5.

FIG. 7 is a graph of noise suppression gain in response to a signal's a posteriori speech-to-noise ratio (“SNR”) and estimated a priori SNR, in accordance with one example of the illustrative embodiments.

FIG. 8 is a graph that shows example levels of a signal and an estimated noise floor, as they vary over time.

### DETAILED DESCRIPTION

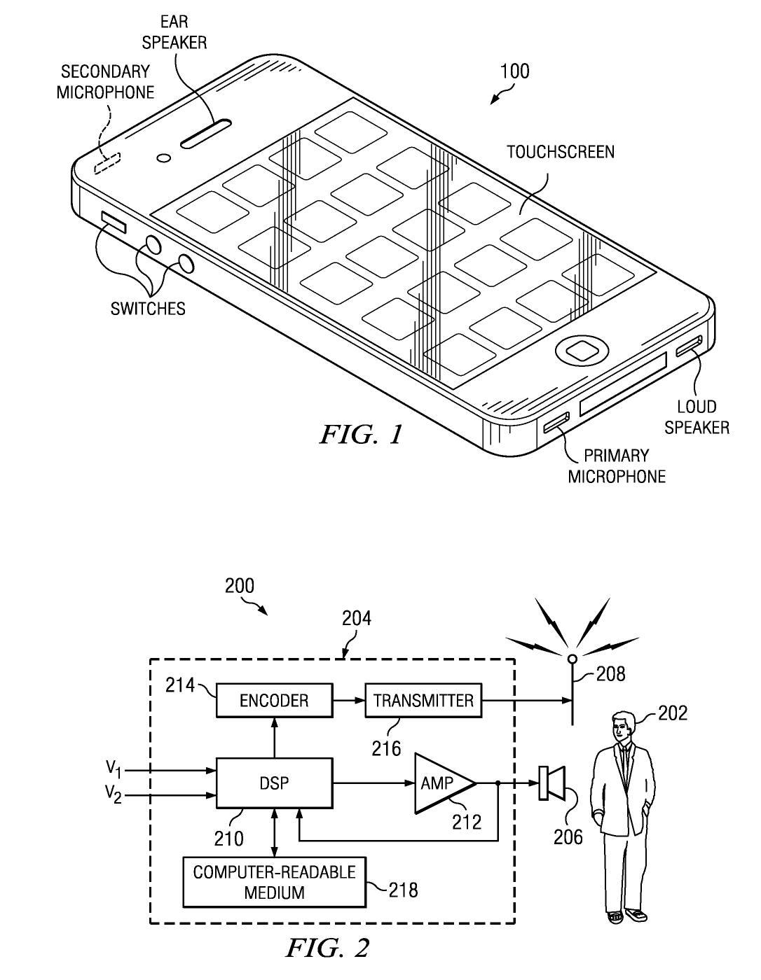

FIG. 1 is a perspective view of a mobile smartphone, indicated generally at 100, that includes an information handling system of the illustrative embodiments. In this example, the smartphone 100 includes a primary microphone, a secondary microphone, an ear speaker, and a loud speaker, as shown in FIG. 1. Also, the smartphone 100 includes a touchscreen and various switches for manually controlling an operation of the smartphone 100.

FIG. 2 is a block diagram of the information handling system, indicated generally at 200, of the illustrative embodiments. A human user 202 speaks into the primary microphone (FIG. 1), which converts sound waves of the speech (from the user 202) into a primary voltage signal V₁. The secondary microphone (FIG. 1) converts sound waves of noise (e.g., from an ambient environment that surrounds the smartphone 100) into a secondary voltage signal V₂. Also, the signal V₁ contains the noise, and the signal V₂ contains leakage of the speech.

A control device 204 receives the signal V₁ (which represents the speech and the noise) from the primary microphone and the signal V₂ (which represents the noise and leakage of the speech) from the secondary microphone. In response to the signals V₁ and V₂, the control device 204 outputs: (a) a first electrical signal to a speaker 206; and (b) a second electrical signal to an antenna 208. The first electrical signal and the second electrical signal communicate speech from the signals V₁ and V₂, while suppressing at least some noise from the signals V₁ and V₂.

In response to the first electrical signal, the speaker 206 outputs sound waves, at least some of which are audible to the human user 202. In response to the second electrical signal, the antenna 208 outputs a wireless telecommunication signal (e.g., through a cellular telephone network to other smartphones). In the illustrative embodiments, the control device 204, the speaker 206 and the antenna 208 are components of the smartphone 100, whose various components are housed integrally with one another. Accordingly in a first example, the speaker 206 is the ear speaker of the smartphone 100. In a second example, the speaker 206 is the loud speaker of the smartphone 100.

The control device 204 includes various electronic circuitry components for performing the control device 204 operations, such as: (a) a digital signal processor (“DSP”) 210, which is a computational resource for executing and otherwise processing instructions, and for performing additional operations (e.g., communicating information) in response thereto; (b) an amplifier (“AMP”) 212 for outputting the first electrical signal to the speaker 206 in response to information from the DSP 210; (c) an encoder 214 for outputting an encoded bit stream in response to information from the DSP 210; (d) a transmitter 216 for outputting the second electrical signal to the antenna 208 in response to the encoded bit stream; (e) a computer-readable medium 218 (e.g., a nonvolatile memory device) for storing information; and (f) various other electronic circuitry (not shown in FIG. 2) for performing other operations of the control device 204.

The DSP 210 receives instructions of computer-readable software programs that are stored on the computer-readable medium 218. In response to such instructions, the DSP 210 executes such programs and performs its operations, so that the first electrical signal and the second electrical signal communicate speech from the signals V₁ and V₂, while suppressing at least some noise from the signals V₁ and V₂. For executing such programs, the DSP 210 processes data, which are stored in memory of the DSP 210 and/or in the computer-readable medium 218. Optionally, the DSP 210 also receives the first electrical signal from the amplifier 212, so that the DSP 210 controls the first electrical signal in a feedback loop.

In an alternative embodiment, the primary microphone (FIG. 1), the secondary microphone (FIG. 1), the control device 204 and the speaker 206 are components of a hearing aid for insertion within an ear canal of the user 202. In one version of such alternative embodiment, the hearing aid omits the antenna 208, the encoder 214 and the transmitter 216.

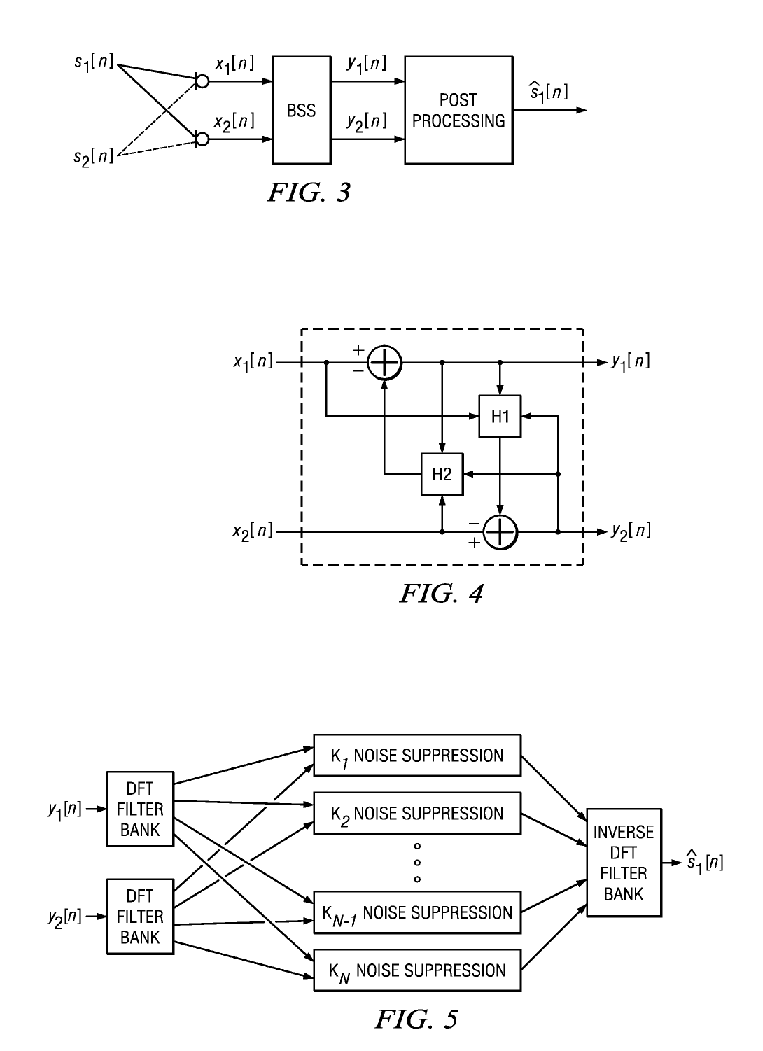

FIG. 3 is an information flow diagram of an operation of the system 200. In accordance with FIG. 3, the DSP 210 performs an adaptive linear filter operation to separate the speech from the noise. In FIG. 3, s₁[n] and s₂[n] represent the speech (from the user 202) and the noise (e.g., from an ambient environment that surrounds the smartphone 100), respectively, during a time frame n. Further, x₁[n] and x₂[n] are digitized versions of the signals V₁ and V₂, respectively, of FIG. 2.

Accordingly: (a) x₁[n] contains information that primarily represents the speech, but also the noise; and (b) x₂[n] contains information that primarily represents the noise, but also leakage of the speech. The noise includes directional noise (e.g., a different person's background speech) and diffused noise. The DSP 210 performs a dual-microphone blind source separation (“BSS”) operation, which generates y₁[n] and y₂[n] in response to x₁[n] and x₂[n], so that: (a) y₁[n] is a primary channel of information that represents the speech and the diffused noise while suppressing most of the directional noise from x₁[n]; and (b) y₂[n] is a secondary channel of information that represents the noise while suppressing most of the speech from x₂[n].

After the BSS operation, the DSP 210 performs a non-linear post processing operation for suppressing noise, without estimating a phase of y₁[n]. In the post processing operation, the DSP 210: (a) in response to y₂[n], estimates the diffused noise within y₁[n]; and (b) in response to such estimate, generates ŝ₁[n], which is an output channel of information that represents the speech while suppressing most of the noise from y₁[n]. As discussed hereinabove in connection with FIG. 2, the DSP 210 outputs such ŝ₁[n] information to: (a) the AMP 212, which outputs the first electrical signal to the speaker 206 in response to such ŝ₁[n] information; and (b) the encoder 214, which outputs the encoded bit stream to the transmitter 216 in response to such ŝ₁[n] information. Optionally, the DSP 210 writes such ŝ₁[n] information for storage on the computer-readable medium 218.

FIG. 4 is an information flow diagram of the BSS operation of FIG. 3. A speech estimation filter H1: (a) receives x₁[n], y₁[n] and y₂[n]; and (b) in response thereto, adaptively outputs an estimate of speech that exists within y₁[n]. A noise estimation filter H2: (a) receives x₂[n], y₁[n] and y₂[n]; and (b) in response thereto, adaptively outputs an estimate of directional noise that exists within y₂[n].

As shown in FIG. 4, y₁[n] is a difference between: (a) x₁[n]; and (b) such estimated directional noise from the noise estimation filter H2. In that manner, the BSS operation iteratively removes such estimated directional noise from x₁[n], so that y₁[n] is a primary channel of information that represents the speech and the diffused noise while suppressing most of the directional noise from x₁[n]. Further, as shown in FIG. 4, y₂[n] is a difference between: (a) x₂[n]; and (b) such estimated speech from the speech estimation filter H1. In that manner, the BSS operation iteratively removes such estimated speech from x₂[n], so that y₂[n] is a secondary channel of information that represents the noise while suppressing most of the speech from x₂[n].

The filters H1 and H2 are adapted to reduce cross-correlation between y₁[n] and y₂[n], so that their filter lengths (e.g., 20 filter taps) are sufficient for estimating: (a) a path of the speech from the primary channel to the secondary channel; and (b) a path of the directional noise from the secondary channel to the primary channel. In the BSS operation, the DSP 210 estimates a level of a noise floor (“noise level”) and a level of the speech (“speech level”).

The DSP 210 computes the speech level by autoregressive (“AR”) smoothing (e.g., with a time constant of 20 ms). The DSP 210 estimates the speech level as Pₛ[n]=α·Pₛ[n−1]+(1−α)·y₁[n]², where: (a) α=exp(−1/Fₛτ); (b) P_{S}[n] is a power of the speech during the time frame n; (c) Pₛ[n−1] is a power of the speech during the immediately preceding time frame n−1; and (d) Fₛ is a sampling rate. In one example, α=0.95, and τ=0.02.

The DSP 210 estimates the noise level (e.g., once per 10 ms) as: (a) if Pₛ[n]>P_{N}[n−1]·Cᵤ, then P_{N}[n]=P_{N}[n−1]·Cᵤ, where P_{N}[n] is a power of the noise level during the time frame n, P_{N}[n−1] is a power of the noise level during the immediately preceding time frame n−1, and Cᵤ is an upward time constant; or (b) if Pₛ[n]<P_{N}[n−1]·C_{d}, then P_{N}[n]=P_{N}[n−1]·C_{d}, where C_{d} is a downward time constant; or (c) if neither (a) nor (b) is true, then P_{N}[n]=Pₛ[n]. In one example, Cᵤ is 3 dB/sec, and C_{d} is −24 dB/sec.

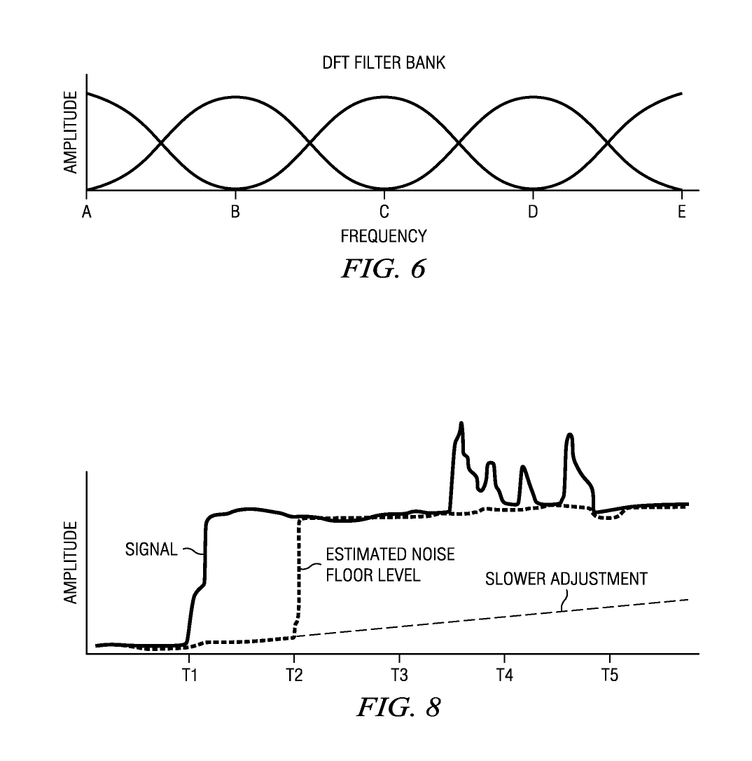

FIG. 5 is an information flow diagram of the post processing operation. FIG. 6 is a graph of various frequency bands that are applied by a discrete Fourier transform (“DFT”) filter bank operation of FIG. 5. As shown in FIG. 6, each frequency band partially overlaps its neighboring frequency bands by fifty percent (50%) apiece. For example, in FIG. 6, one frequency band ranges from B Hz to D Hz, and such frequency band partially overlaps: (a) a frequency band that ranges from A Hz to C Hz; and (b) a frequency band that ranges from C Hz to E Hz.

A particular band is referenced as the kth band, where: (a) k is an integer that ranges from 1 through N; and (b) N is a total number of such bands. In the illustrative embodiment, N=64. Referring again to FIG. 5, in the DFT filter bank operation, the DSP 210: (a) receives y₁[n] and y₂[n] from the BSS operation; (b) converts y₁[n] from a time domain to a frequency domain, and decomposes the frequency domain version of y₁[n] into a primary channel of the N bands, which are y₁[n, 1] through y₁[n, N]; and (c) converts y₂[n] from time domain to frequency domain, and decomposes the frequency domain version of y₂[n] into a secondary channel of the N bands, which are y₂[n, 1] through y₂[n, N].

As shown in FIG. 5, for each of the N bands, the DSP 210 performs a noise suppression operation, such as a spectral subtraction operation, minimum mean-square error (“MMSE”) operation, or maximum likelihood (“ML”) operation. For the kth band, such operation is denoted as the Kₖ noise suppression operation. Accordingly, in the Kₖ noise suppression operation, the DSP 210: (a) in response to the secondary channel's kth band y₂[n, k], estimates the diffused noise within the primary channel's kth band y₁[n, k]; (b) in response to such estimate, computes the kth band's respective noise suppression gain G[n, k] for the time frame n; and (c) generates a respective noise-suppressed version ŝ₁[n, k] of the primary channel's kth band y₁[n, k] by applying G[n, k] thereto (e.g., by multiplying G[n, k] and the primary channel's kth band y₁[n, k] for the time frame n). After the DSP 210 generates the respective noise-suppressed versions ŝ₁[n, k] of all N bands of the primary channel for the time frame n, the DSP 210 composes ŝ₁[n] for the time frame n by performing an inverse of the DFT filter bank operation, in order to convert a sum of those noise-suppressed versions ŝ₁[n, k] from a frequency domain to a time domain. In real-time causal implementations of the system 200, a band's G[n, k] is variable per time frame n.

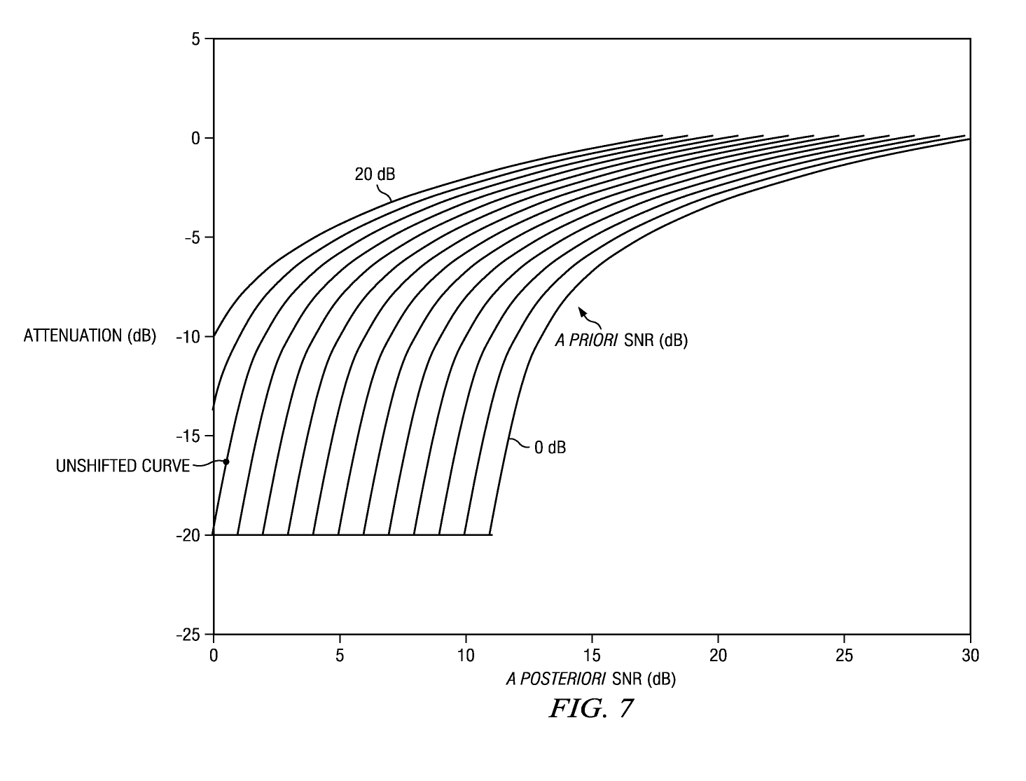

FIG. 7 is a graph of noise suppression gain G[n, k] in response to a signal's a posteriori SNR and estimated a priori SNR, in accordance with one example of the illustrative embodiments. Accordingly, in the illustrative embodiments, the DSP 210 computes the kth band's respective noise suppression gain G[n, k] in response to both: (a) a posteriori SNR, which is a logarithmic ratio between a noisy version of the signal's energy (e.g., speech and diffused noise as represented by y₁[n, k]) and the noise's energy (e.g., as represented by y₂[n, k]); and (b) estimated a priori SNR, which is a logarithmic ratio between a clean version of the signal's energy (e.g., as estimated by the DSP 210) and the noise's energy (e.g., as represented by y₂[n, k]). During the time frame n, the kth band's then-current a priori SNR is not yet determined exactly, so the DSP 210 updates its decision-directed estimate of the kth band's then-current a priori SNR in response to G[n−1, k] and y₁[n−1, k] for the immediately preceding time frame n−1.

For the time frame n, the DSP 210 computes:

P_{y}_{₁}[n,k]=α·P_{y}_{₁}[n,k]+(1−α)·(y₁_{_{R}}[n,k]²+y₁_{_{I}}[n,k]²), and

P_{y}_{₂}[n,k]=α·P_{y}_{₂}[n,k]+(1−α)·(y₂_{_{R}}[n,k]²+y₂_{_{I}}[n,k]²),

where: (a) P_{y}_{₁}[n, k] is AR smoothed power of y₁[n, k] in the kth band; (b) P_{y}_{₂}[n, k] is AR smoothed power of y₂[n, k] in the kth band; (c) y₁_{_{R}}[n, k] and y₁_{_{I}}[n, k] are real and imaginary parts of y₁[n, k]; and (d) y₂_{_{R}}[n, k] and y₂_{_{I}}[n, k] are real and imaginary parts of y₂[n, k]. In one example, α=0.95.

The DSP 210 computes its estimate of a priori SNR as:

a priori SNR=Pₛ[n−1,k]/P_{y}_{₂}[n−1,k],

where: (a) Pₛ[n−1, k] is estimated power of clean speech for the immediately preceding time frame n−1; and (b) P_{y}_{₂}[n−1, k] is AR smoothed power of y₂[n−1, k] in the kth band for the immediately preceding time frame n−1.

However, if P_{y}_{₂}[n−1, k] is unavailable (e.g., if the secondary voltage signal V₂ is unavailable), then the DSP 210 computes its estimate of a priori SNR as:

a priori SNR=Pₛ[n−1,k]/P_{N}[n−1,k],

where: (a) P_{N}[n−1, k] is an estimate of noise level within y₁[n−1, k]; and (b) the DSP 210 estimates P_{N}[n−1, k] in the same manner as discussed hereinbelow in connection with FIG. 8.

The DSP 210 computes Pₛ[n−1, k] as:

Pₛ[n−1,k]=G[n−1,k]²·P_{y}_{₁}[n−1,k],

where: (a) G[n−1, k] is the kth band's respective noise suppression gain for the immediately preceding time frame n−1; and (b) P_{y}_{₁}[n−1, k] is AR smoothed power of y₁[n−1, k] in the kth band for the immediately preceding time frame n−1.

The DSP 210 computes a posteriori SNR as:

a posteriori SNR=P_{y}_{₁}[n,k]/P_{y}_{₂}[n,k].

However, if P_{y}_{₂}[n, k] is unavailable (e.g., if the secondary voltage signal V₂ is unavailable), then the DSP 210 computes a posteriori SNR as:

a posteriori SNR=P_{y}_{₁}[n,k]/P_{N}[n,k],

where: (a) P_{N}[n, k] is an estimate of noise level within y₁[n, k]; and (b) the DSP 210 estimates P_{N}[n, k] in the same manner as discussed hereinbelow in connection with FIG. 8.

In FIG. 7, various spectral subtraction curves show how G[n, k] (“attenuation”) varies in response to both a posteriori SNR and estimated a priori SNR. One of those curves (“unshifted curve”) is a baseline curve of a relationship between a posteriori SNR and G[n, k]. But the DSP 210 shifts the baseline curve horizontally (either left or right by a variable amount X) in response to estimated a priori SNR, as shown by the remaining curves of FIG. 7. A relationship between curve shift X and estimated a priori SNR was experimentally determined as X=estimated a priori SNR−15 dB.

For example, if estimated a priori SNR is relatively high, then X is positive, so that the DSP 210 shifts the baseline curve left (which effectively increases G[n, k]), because the positive X indicates that y₁[n, k] likely represents a smaller percentage of noise. Conversely, if estimated a priori SNR is relatively low, then X is negative, so that the DSP 210 shifts the baseline curve right (which effectively reduces G[n, k]), because the negative X indicates that y₁[n, k] likely represents a larger percentage of noise. In this manner, the DSP 210 smooths G[n, k] transition and thereby reduces its rate of change, so that the DSP 210 reduces an extent of annoying musical noise artifacts (but without producing excessive smoothing distortion, such as reverberation), while nevertheless updating G[n, k] with sufficient frequency to handle relatively fast changes in the signals V₁ and V₂. To further achieve those objectives in various embodiments, the DSP 210 shifts the baseline curve horizontally (either left or right by a first variable amount) and/or vertically (either up or down by a second variable amount) in response to estimated a priori SNR, so that the baseline curve shifts in one dimension (e.g., either horizontally or vertically) or multiple dimensions (e.g., both horizontally and vertically).

In one example of the illustrative embodiments, the DSP 210 implements the curve shift X by precomputing an attenuation table of G[n, k] values (in response to various combinations of a posteriori SNR and estimated a priori SNR) for storage on the computer-readable medium 218, so that the DSP 210 determines G[n, k] in real-time operation by reading G[n, k] from such attenuation table in response to a posteriori SNR and estimated a priori SNR. In one version of the illustrative embodiments, the DSP 210 implements the curve shift X by computing G[n, k] as:

G[n,k]=√(1−(10^{0.1·CurveSNR})^{0.01},

where CurveSNR=X·a posteriori SNR.

However, the DSP 210 imposes a floor on G[n, k] to ensure that G[n, k] is always greater than or equal to a value of the floor, which is programmable as a runtime parameter. In that manner, the DSP 210 further reduces an extent of annoying musical noise artifacts. In the example of FIG. 7, such floor value is −20 dB.

FIG. 8 is a graph that shows example levels of Pₓ_{₁}[n] and P_{N}[n], as they vary over time, where: (a) Pₓ_{₁}[n] is a power of x₁[n]; (b) Pₓ_{₁}[n] is denoted as “signal” in FIG. 8; and (c) P_{N}[n] is denoted as “estimated noise floor level” in FIG. 8. In the example of FIG. 8, the DSP 210 estimates P_{N}[n] in response to Pₓ_{₁}[n] for the BSS operation of FIGS. 3 and 4. In another example, if P_{y}_{₂}[n, k] is unavailable (e.g., if the secondary voltage signal V₂ is unavailable), then the DSP 210 estimates P_{N}[n] in response to P_{y}_{₁}[n] (instead of Pₓ_{₁}[n]) for the post processing operation of FIGS. 3 and 5, as discussed hereinabove in connection with FIG. 7.

In response to Pₓ_{₁}[n] exceeding P_{N}[n] by more than a specified amount (“GAP”) for more than a specified continuous duration, the DSP 210: (a) determines that such excess is more likely representative of noise level increase instead of speech; and (b) accelerates its adjustment of P_{N}[n]. In the illustrative embodiments, the DSP 210 measures the specified continuous duration as a specified number (“MAX”) of consecutive time frames, which aggregately equate to at least such duration (e.g., 0.8 seconds).

In response to Pₓ_{₁}[n] exceeding P_{N}[n] by less than GAP and/or for less than MAX consecutive time frames (e.g., between a time T3 and a time T5 in the example of FIG. 8), the DSP 210 determines that such excess is more likely representative of speech instead of additional noise. For example, if Pₓ_{₁}[n]≦P_{N}[n]·GAP, then Count[n]=0, and the DSP 210 clears an initialization flag. In response to the initialization flag being cleared, the DSP 210 estimates P_{N}[n] according to the time constants Cᵤ and C_{d} (discussed hereinabove in connection with FIG. 4), so that P_{N}[n] falls more quickly than it rises.

Conversely, if Pₓ_{₁}[n]>P_{N}[n]·GAP, then Count[n]=Count[n−1]+1. If Count[n]>MAX, then the DSP 210 sets the initialization flag. In response to the initialization flag being set, the DSP 210 estimates P_{N}[n] with a faster time constant (e.g., in the same manner as the DSP 210 estimates Pₛ[n] discussed hereinabove in connection with FIG. 4), so that P_{N}[n] rises approximately as quickly as it falls. In an alternative embodiment, instead of determining whether Pₓ_{₁}[n]≦P_{N}[n]·GAP, the DSP 210 determines whether Pₓ_{₁}[n]≦P_{N}[n]+GAP, so that: (a), if Pₓ_{₁}[n]≦P_{N}[n]+GAP, then Count[n]=0, and the DSP 210 clears the initialization flag; and (b) if Pₓ_{₁}[n]>P_{N}[n]+GAP, then Count[n]=Count[n−1]+1.

In the example of FIG. 8: (a) Pₓ_{₁}[n] quickly rises at a time T1; (b) shortly after T1, Pₓ_{₁}[n] exceeds P_{N}[n] by more than GAP; (c) at a time T2, more than MAX consecutive time frames have elapsed since T1; and (d) in response to Pₓ_{₁}[n] exceeding P_{N}[n] by more than GAP for more than MAX consecutive time frames, the DSP 210 sets the initialization flag and estimates P_{N}[n] with the faster time constant. By comparison, if the DSP 210 always estimated P_{N}[n] according to the time constants Cᵤ and C_{d}, then the DSP 210 would have adjusted P_{N}[n] with less precision and less speed (e.g., as shown by the “slower adjustment” line of FIG. 8). Also, in one embodiment, while initially adjusting P_{N}[n] during its first 0.5 seconds of operation, the DSP 210 sets the initialization flag and estimates P_{N}[n] with the faster time constant.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A method performed by an information handling system for attenuating noise, the method comprising:
receiving a first signal that represents speech and the noise, wherein the noise includes directional noise and diffused noise;
receiving a second signal that represents the noise and leakage of the speech;
in response to the first and second signals, generating a first channel that represents the speech and the diffused noise while attenuating most of the directional noise from the first signal, and generating a second channel that represents the noise while attenuating most of the speech from the second signal; and
in response to the first and second channels, generating an output channel that represents the speech while attenuating most of the noise from the first channel.

2. The method of claim 1, wherein receiving the first signal includes receiving the first signal from a first microphone, and wherein receiving the second signal includes receiving the second signal from a second microphone.

3. The method of claim 1, wherein generating the output channel includes generating frequency bands of the output channel, wherein the frequency bands include at least N frequency bands, wherein k is an integer number that ranges from 1 through N, and wherein generating a kth frequency band of the output channel includes attenuating noise in the kth frequency band.

4. The method of claim 3, wherein attenuating noise in the kth frequency band includes performing at least one of: a spectral subtraction operation; a minimum mean-square error operation; and a maximum likelihood operation.

5. The method of claim 3, and comprising: performing a first filter bank operation for converting a time domain version of the first channel to at least N frequency bands of the first channel; and performing a second filter bank operation for converting a time domain version of the second channel to at least N frequency bands of the second channel.

6. The method of claim 5, wherein generating the output channel includes: performing an inverse of the first filter bank operation for converting a sum of the frequency bands of the output channel to a time domain.

7. The method of claim 5, wherein the frequency bands include at least first and second frequency bands that partially overlap one another.

8. The method of claim 5, wherein generating the kth frequency band of the output channel includes: generating the kth frequency band of the output channel in response to the kth frequency band of the first channel, and in response to the kth frequency band of the second channel.

9. The method of claim 8, wherein generating a kth frequency band of the output channel includes: determining a gain in response to the kth frequency band of the first channel, and in response to the kth frequency band of the second channel; and generating the kth frequency band of the output channel in response to multiplying the gain and the kth frequency band of the first channel.

10. A system for attenuating noise, the system comprising:
at least one device for: receiving a first signal that represents speech and the noise, wherein the noise includes directional noise and diffused noise; receiving a second signal that represents the noise and leakage of the speech; in response to the first and second signals, generating a first channel that represents the speech and the diffused noise while attenuating most of the directional noise from the first signal, and generating a second channel that represents the noise while attenuating most of the speech from the second signal; and, in response to the first and second channels, generating an output channel that represents the speech while attenuating most of the noise from the first channel.

11. The system of claim 10, wherein receiving the first signal includes receiving the first signal from a first microphone, and wherein receiving the second signal includes receiving the second signal from a second microphone.

12. The system of claim 10, wherein generating the output channel includes generating frequency bands of the output channel, wherein the frequency bands include at least N frequency bands, wherein k is an integer number that ranges from 1 through N, and wherein generating a kth frequency band of the output channel includes attenuating noise in the kth frequency band.

13. The system of claim 12, wherein attenuating noise in the kth frequency band includes performing at least one of: a spectral subtraction operation; a minimum mean-square error operation; and a maximum likelihood operation.

14. The system of claim 12, wherein the at least one device is for: performing a first filter bank operation for converting a time domain version of the first channel to at least N frequency bands of the first channel; and performing a second filter bank operation for converting a time domain version of the second channel to at least N frequency bands of the second channel.

15. The system of claim 14, wherein generating the output channel includes: performing an inverse of the first filter bank operation for converting a sum of the frequency bands of the output channel to a time domain.

16. The system of claim 14, wherein the frequency bands include at least first and second frequency bands that partially overlap one another.

17. The system of claim 14, wherein generating the kth frequency band of the output channel includes: generating the kth frequency band of the output channel in response to the kth frequency band of the first channel, and in response to the kth frequency band of the second channel.

18. The system of claim 17, wherein generating a kth frequency band of the output channel includes: determining a gain in response to the kth frequency band of the first channel, and in response to the kth frequency band of the second channel; and generating the kth frequency band of the output channel in response to multiplying the gain and the kth frequency band of the first channel.

19. A computer program product for attenuating noise, the computer program product comprising:
a tangible computer-readable storage medium; and
a computer-readable program stored on the tangible computer-readable storage medium, wherein the computer-readable program is processable by an information handling system for causing the information handling system to perform operations including: receiving a first signal that represents speech and the noise, wherein the noise includes directional noise and diffused noise; receiving a second signal that represents the noise and leakage of the speech; in response to the first and second signals, generating a first channel that represents the speech and the diffused noise while attenuating most of the directional noise from the first signal, and generating a second channel that represents the noise while attenuating most of the speech from the second signal; and, in response to the first and second channels, generating an output channel that represents the speech while attenuating most of the noise from the first channel.

20. The computer program product of claim 19, wherein receiving the first signal includes receiving the first signal from a first microphone, and wherein receiving the second signal includes receiving the second signal from a second microphone.

21. The computer program product of claim 19, wherein generating the output channel includes generating frequency bands of the output channel, wherein the frequency bands include at least N frequency bands, wherein k is an integer number that ranges from 1 through N, and wherein generating a kth frequency band of the output channel includes attenuating noise in the kth frequency band.

22. The computer program product of claim 21, wherein attenuating noise in the kth frequency band includes performing at least one of: a spectral subtraction operation; a minimum mean-square error operation; and a maximum likelihood operation.

23. The computer program product of claim 21, wherein the operations include: performing a first filter bank operation for converting a time domain version of the first channel to at least N frequency bands of the first channel; and performing a second filter bank operation for converting a time domain version of the second channel to at least N frequency bands of the second channel.

24. The computer program product of claim 23, wherein generating the output channel includes: performing an inverse of the first filter bank operation for converting a sum of the frequency bands of the output channel to a time domain.

25. The computer program product of claim 23, wherein the frequency bands include at least first and second frequency bands that partially overlap one another.

26. The computer program product of claim 23, wherein generating the kth frequency band of the output channel includes: generating the kth frequency band of the output channel in response to the kth frequency band of the first channel, and in response to the kth frequency band of the second channel.

27. The computer program product of claim 26, wherein generating a kth frequency band of the output channel includes: determining a gain in response to the kth frequency band of the first channel, and in response to the kth frequency band of the second channel; and generating the kth frequency band of the output channel in response to multiplying the gain and the kth frequency band of the first channel.
